(19) United States
(12) Patent Application Publication
(10) Pub. No.: US 2010/0226036 A1
(43) Pub. Date: Sep. 9, 2010

(54) DISK DRIVE HAVING MAGNETIC DISK OF PATTERNED MEDIA TYPE

(75) Inventor: Yasuyuki Ozawa, Tama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/715,937

(22) Filed: Mar. 2, 2010

(30) Foreign Application Priority Data
Mar. 3, 2009 (JP) 2009-049964

(51) Int. Cl. G11B 21/02; G11B 5/82

(52) U.S. Cl. 360/75; 360/135; G9B/5.293; G9B/21.003

(57) ABSTRACT

According to one embodiment, a magnetic disk of a patterned media type, has a plurality of zones divided in radial direction on a magnetic recording surface. A plurality of segments which are included in each of the zones includes a data recording area composed of data recording unit of magnetic material and a first resync area in which a reference signal pattern for setting the timing of writing data in the data recording area has been recorded. The number of segments included in each of the zones is an integer and has a common divisor.

### CROSS-REFERENCE TO RELATED APPLICATIONS

This application is based upon and claims the benefit of priority from Japanese Patent Application No. 2009-049964, filed Mar. 3, 2009, the entire contents of which are incorporated herein by reference.

### BACKGROUND

1. Field

One embodiment of the invention relates to a disk drive using a magnetic disk of the patterned media type.

2. Description of the Related Art

In the field of disk drives, magnetic disks of the patterned media type have received attention in recent years as a recording medium using the technique for increasing the recording density. At the surface of a magnetic disk of this type, bit patterns made of recordable magnetic material have been arranged, which increases the surface recording density.

In a magnetic disk of the patterned media type, one magnetic body (or dot) corresponds to a 1-bit bit pattern. A value of 0 or 1 is determined, depending on the magnetization direction of the dot. Accordingly, data cannot be recorded between bit patterns on the magnetic disk. For this reason, it is necessary to record data on the disk after positioning the magnetic head (or recording element) precisely on a bit pattern.

Specifically, the disk drive positions the magnetic head (or recording element) in the radial position on the magnetic disk and generates a write clock in synchronism with the bit pattern. Using the write clock, the disk drive records data in the bit pattern on which the magnetic head has been positioned.

As the conventional art corresponding to the patterned media type, the technique related to the write preamble method has been proposed (e.g., refer to Jpn. Pat. Appln. KOKAI Publication No. 2002-368124). In addition, the conventional art related to the resync method has been proposed (e.g., refer to Jpn. Pat. Appln. KOKAI Publication No. 2003-157507).

In the conventional art, a disk using the resync method is so configured that each of hundreds of sectors equally divided circumferentially has a servo area, a write preamble and a data area. The data area includes a plurality of data segments. Each of the data segments includes a recording dot area including a plurality of bit patterns, and a resync area. The write preamble is used to lock a phase-locked loop circuit (PLL circuit) so that the write clock may have not only the same frequency as that of the arrangement of the bit pattern but also a suitable phase. The resync area is used to lock the PLL circuit again to maintain the frequency and phase suitably in one sector.

In a disk drive, data is normally managed in modules of a specific capacity (e.g., in modules of 512 bytes). Accordingly, it is desirable that each of the recording dot areas in the data area should have a capacity in which a data management module (i.e., 512 bytes) of data and additional data, such as an error correction code (ECC), can be recorded. If all of a data management module of data cannot be recorded in the last recording dot area in a sector, it is necessary to add additional data to the data that could not be recorded and record the resulting data in the leading part of the next sector. This results in a decrease in the efficiency of recording and reproducing data and an increase in the complexity of the recording and reproduction circuit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram to explain the configuration of a disk drive according to an embodiment of the invention;

FIG. 2 shows the configuration of a magnetic disk according to the embodiment;

FIG. 3 is a diagram to explain data segments according to the embodiment;

FIG. 4 is a table to explain a data format of the magnetic disk according to the embodiment;

FIG. 5 is a diagram to explain the division between a data area and a servo area in the magnetic disk according to the embodiment;

FIG. 6 is an enlarged view of the vicinity of boundary line B1 shown in FIG. 5;

FIG. 7 shows the positional relationship between the servo area and resync area in the embodiment;

FIG. 8 shows the positional relationship between the recording dot area and resync area in the embodiment;

FIG. 9 shows the configuration of a clock generation PLL circuit according to the embodiment;

FIGS. 10A and 10B show recording dot areas and a write clock in the embodiment;

FIGS. 11A, 11B, and 11C are diagrams to explain the structure of a magnetic disk according to a modification of the embodiment; and

FIG. 12 shows the configuration of a clock generation PLL circuit according to a modification of the embodiment.

### DETAILED DESCRIPTION

Various embodiments according to the invention will be described hereinafter with reference to the accompanying drawings. According to the embodiment, there is provided a disk drive which is capable of increasing the efficiency of recording and reproducing data by using a magnetic disk of a patterned media type.

[Configuration of Disk Drive]

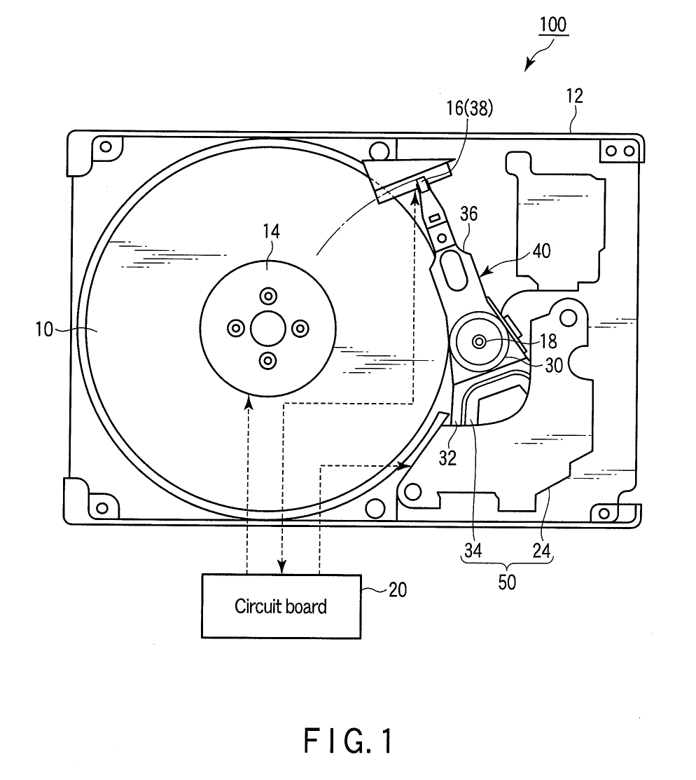

According to the embodiment, FIG. 1 shows the configuration of a disk drive, more specifically a hard disk drive (HDD) 100. In the embodiment, the hard disk drive is referred to as the disk drive 100.

As shown in FIG. 1, the disk drive 100 comprises a box-shaped case 12, a magnetic disk 10 housed in the case 12, a spindle motor 14, a circuit board 20, and a head stack assembly (HSA) 40. The case 12 is actually composed of a base and a top cover. In the embodiment, for convenience sake, only the base is shown as the case 12.

In the magnetic disk 10, both sides of the disk are normally magnetic recording surfaces. The spindle motor 14 rotates the magnetic disk 10 at a high speed, centering on its rotation axis. The revolution speed is in the range of, for example, about 4200 to 15000 rpm. The spindle motor 14 is provided with one or more magnetic disks 10. In the embodiment, for the purpose of convenience, suppose one magnetic disk 10 is used.

The magnetic disk 10 is a magnetic recording medium of either the patterned media type or bit patterned media type. The magnetic disk 10 has a single-crystal, single-domain magnetic film separated in bits on each of its magnetic recording surfaces. The configuration of the magnetic disk 10 will be described later.

The HSA 40 comprises a head slider 16, a cylindrical carriage 30, a fork (or yoke) 32, a coil 34, and a carriage arm 36. The fork 32, which is fixed to the carriage 30, is a material holding the coil 34. The carriage arm 36, which is fixed to the carriage 30, holds the head slider 16. When both sides of the magnetic disk 10 are magnetic recording surfaces, a pair of head sliders 16 and a pair of carriage arms 36 are provided so that they are vertically symmetric with the magnetic disk 10 between them. When a plurality of magnetic disks 10 are provided, a head slider 16 and a carriage arm 36 are provided so as to correspond to the magnetic recording surface of each of the magnetic disks 10.

The carriage arm 36 is casted by, for example, punching a stainless steel plate or extruding an aluminum material. The head slider 16 is provided with the magnetic head 38 which includes a recording element (hereinafter, referred to as a write element) and a reproduction element (hereinafter, referred to as a read element). In the magnetic head, the write element and read element are actually arranged in such a manner that they are separated from each other. In the embodiment, the explanation will be given on the assumption that the write element and read element are located in the same position for the purpose of convenience.

The HSA 40 is coupled with the case 12 via a bearing area material 18 provided in the central area of the carriage 30 in such a manner that the HSA 40 can rotate freely (or rotate on the z-axis freely). In addition, the HSA 40 includes a voice coil motor 50 composed of a coil 34 and a magnetic pole module 24 including a permanent magnet fixed to the base of the case 12. The voice coil 50 moves the carriage 36 forward or backward along an arc track (a dashed-dotted line) centering on the bearing area material 18 of the HSA 40.

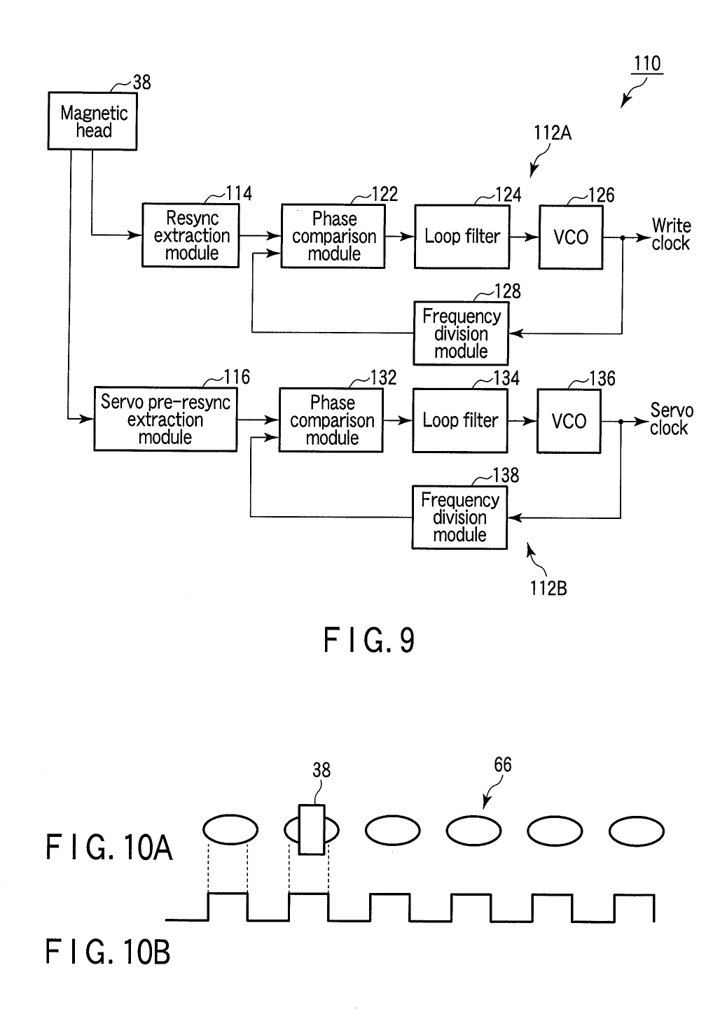

The circuit board 20 is provided with a motor driver, a read/write channel, a hard disk controller (HDC), and a microcomputer (or microprocessor). The hard disk controller (HDC) includes PLL circuit 110 for a clock generation (FIG. 9). The microcomputer, which is a main controller of the disk drive 100, carries out various operations, including servo control to position the magnetic head 38 in a target position on the magnetic disk 10. The PLL circuit 110 generates a clock to reproduce data (including servo data) from the magnetic disk 10 or record data (user data) on the magnetic disk 10.

In the disk drive 100, the magnetic head 38 provided on the head slider 16 writes or reads data (or information) to or from the magnetic disk 10. In this case, the head slider 16 is floated above the surface of the magnetic disk 10 by lift force caused by the rotation of the magnetic disk 10. Accordingly, the magnetic head 38 writes or reads data, keeping a minute spacing with the magnetic disk 10.

As described above, the carriage 36 moves forward or backward in the radial direction on the magnetic disk 10 to cause the magnetic head 38 to move so as to traverse tracks on the magnetic disk 10, thereby changing a track to be written to or read from.

[Configuration of Magnetic Disk]

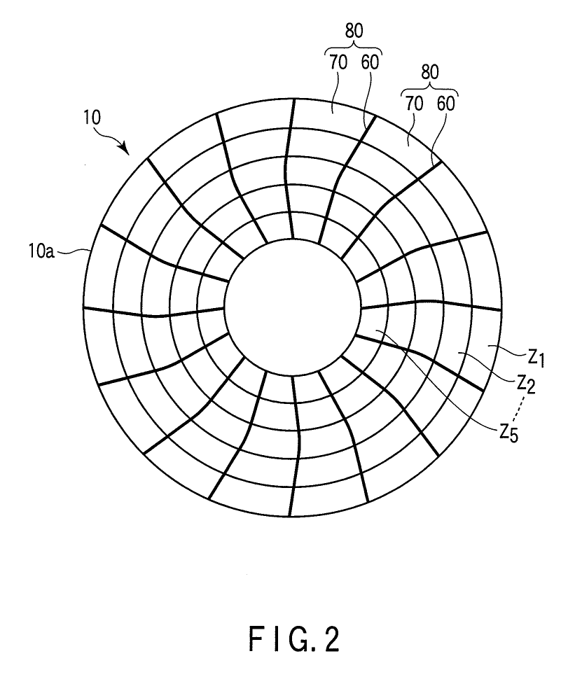

FIG. 2 schematically shows the magnetic disk 10. As shown in FIG. 2, the magnetic disk 10 has a magnetic recording surface is sectionalized into a plurality of zones Z₁ to Zₙ (here, n=5) at regular intervals in the radial direction on the surface of a magnetic disk substrate 10a. In each of zones Z₁ to Z₅ includes a plurality of ring-like tracks. Each of the tracks is configured to have the same width in the radial direction on the magnetic disk 10. Moreover, as shown in FIG. 2, in each of zones Z₁ to Z₅, a servo area 60 and a data area 70 are alternately provided circumferentially. A range including a servo area 60 and a data area 70 is configured to be a sector 80. The servo area 60 is an area in which servo data has been recorded. The data area 70 is an area in which user data is to be recorded. Normally, the number of sectors in each of zones Z₁ to Z₅ is the same.

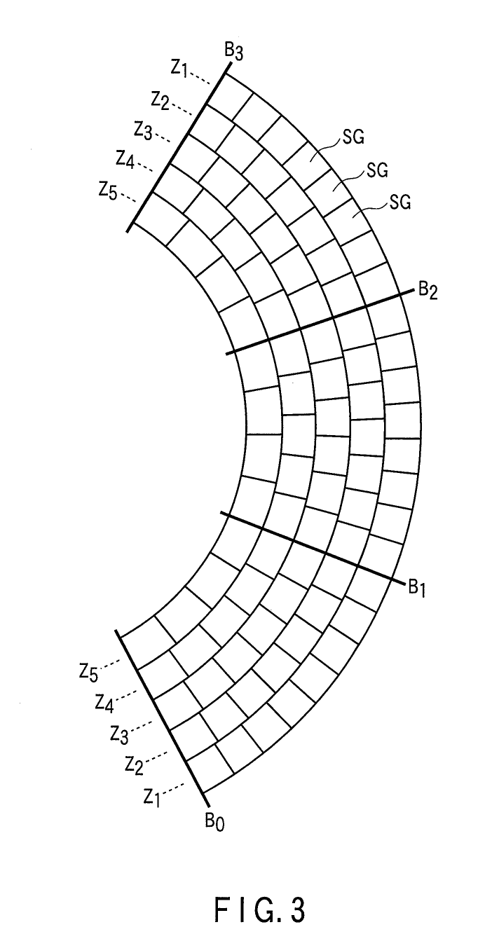

FIG. 3 is an enlarged view of a part of FIG. 2.

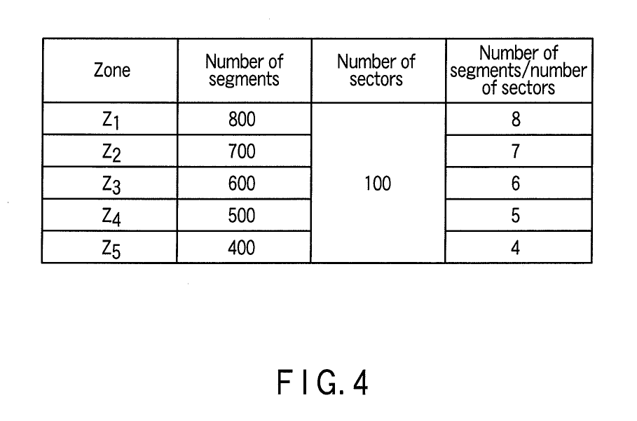

As shown in FIG. 3, each of zones Z₁ to Z₅ on the magnetic disk 10 is divided equally into a plurality of segments (sometimes referred to as data segments) SG. The number of segments in each zone is larger in a place closer to the outer circumference and smaller in a place closer to the inner circumference. Specifically, as shown in FIG. 4, for example, zone Z₁ includes 800 segments, zone Z₂ 700 segments, zone Z₃ 600 segments, zone Z₄ 500 segments, and zone Z₅ 400 segments. In this case, the individual segment numbers are integers and have a common divisor (in this case, M=100). That is, suppose the individual segment numbers are numbers divisible by 100. If the number of segments is Sn and an arbitrary integer is Ln, the number of segments Sn can be expressed by the following equation (1):

Sn=M×Ln (1)

If Ln is defined as Ln=Number of segments/Number of sectors, it follows from equation (1) that the number of sectors is the same number (100) as divisor M. Accordingly, in the embodiment, as shown in FIG. 3, in one sector, the number of segments SG in zone Z₁ is 8, the number of segments SG in zone Z₂ is 7, the number of segments SG in zone Z₃ is 6, the number of segments SG in zone Z₄ is 5, and the number of segments SG in zone Z₅ is 4. Here, the boundary line of each sector (B0 to B3 in FIG. 3) is the leading end of the servo area 60. On the magnetic disk 10, there are at least M boundary lines (100 boundary lines in the embodiment). Although the boundary lines are actually shaped like an arc as shown in FIG. 2, they are shown as straight lines for convenience sake in FIG. 3.

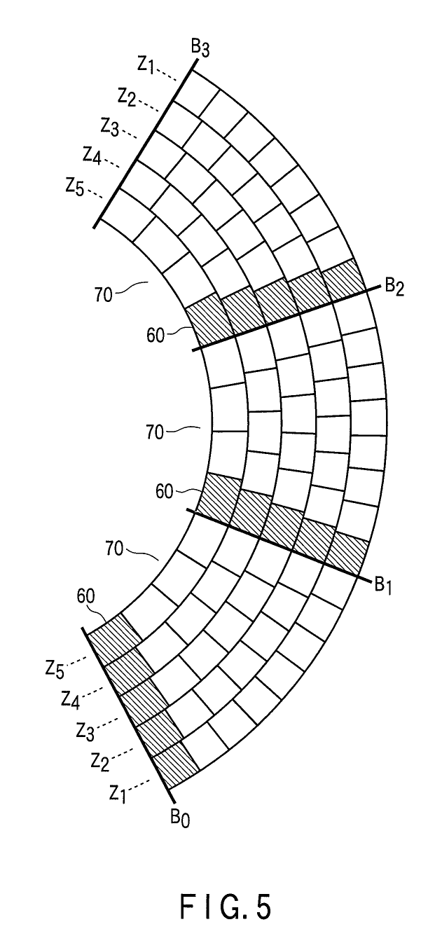

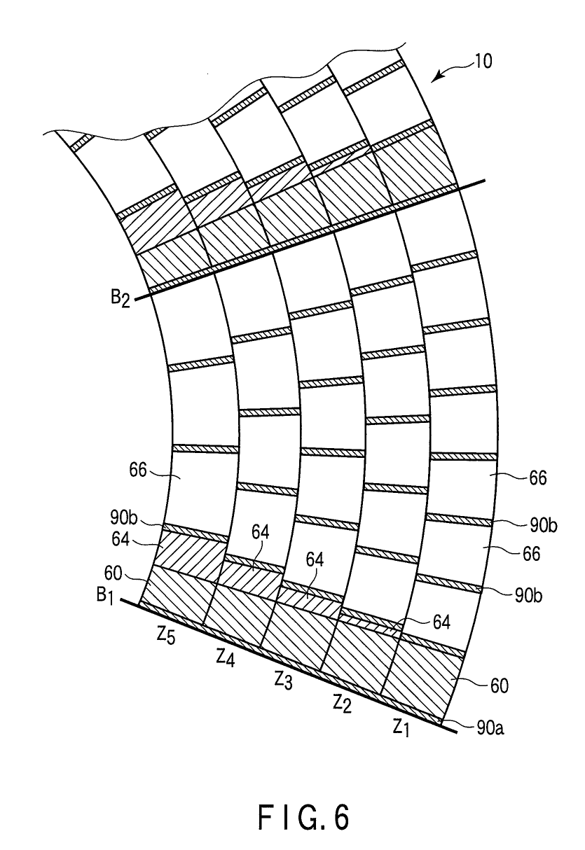

The configuration of the magnetic disk 10 of the embodiment will be explained in detail with reference to FIGS. 5 and 6.

As shown in FIG. 5, the areas (hatched areas) adjoining boundary lines B0, B1, B2, . . . are servo areas 60. The areas excluding the servo areas 60 sectionalized by the individual boundary lines are the data areas 70.

FIG. 6 is an enlarged view of the vicinity of boundary lines B1 and B2 in FIG. 5. As shown in FIG. 6, a segment near boundary line B1 is provided with a servo area 60. The servo area 60 is an area in which servo data has been recorded at a constant angular velocity (CAV). Accordingly, in the servo area 60, zones closer to the outer circumference have a wider width and zones closer to the inner circumference have a narrower width. In the position sandwiched between the servo area 60 and boundary line B1, a resync area 90a (described later) is provided.

Furthermore, as shown in FIG. 6, zones Z₂ to Z₅ are provided with management information recording areas 64 adjoining the servo area 60. Each of the management information recording areas 64 is an area in which management information on the disk drive 100 is recorded. The management information includes the ID number and production lot number of the magnetic disk 10, servo auxiliary data known as post code, disk defect information, replacement sector information in case of a medium failure. The management information is non-user management information different from user data management information.

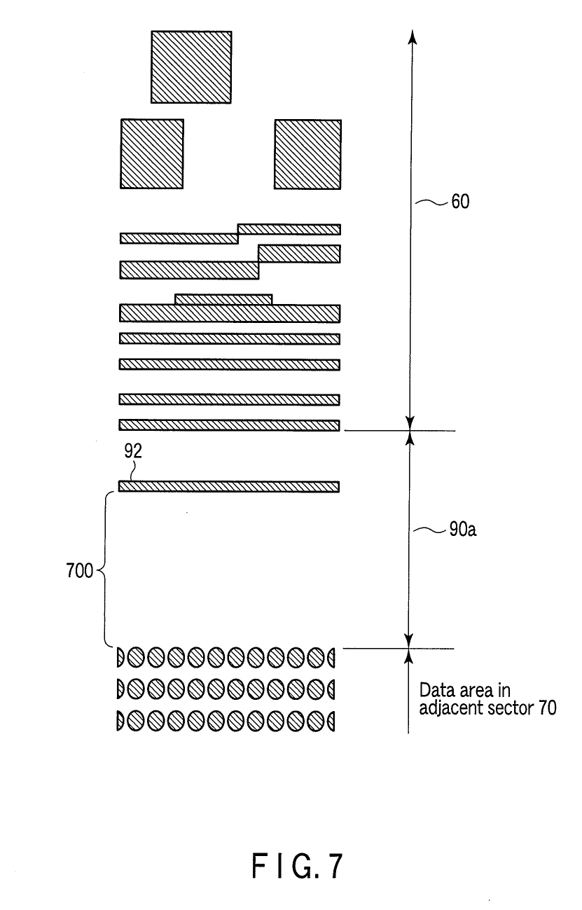

FIG. 7 shows a concrete structure of a resync area 90a and a servo area 60. As shown in FIG. 7, in the resync area 90a, a reference signal pattern 92 necessary for the operation of the clock generation PLL circuit 110 (described later) has been recorded. The reference signal pattern 92 is used as the timing of reading servo data from the servo area 60. A unique distance 700 is provided between the reference signal pattern 92 and the end (or boundary line) of the data area 70 of an adjacent sector.

In the servo area 60, servo data, including a servo mark, a sector number (or sector address), a track number (or track address), and a servo burst signal, has been recorded. Each of the servo area 60 and resync area 90a is composed of a combination of a magnetic material (or a magnetic film) and a nonmagnetic material by a nano-imprint manufacturing method.

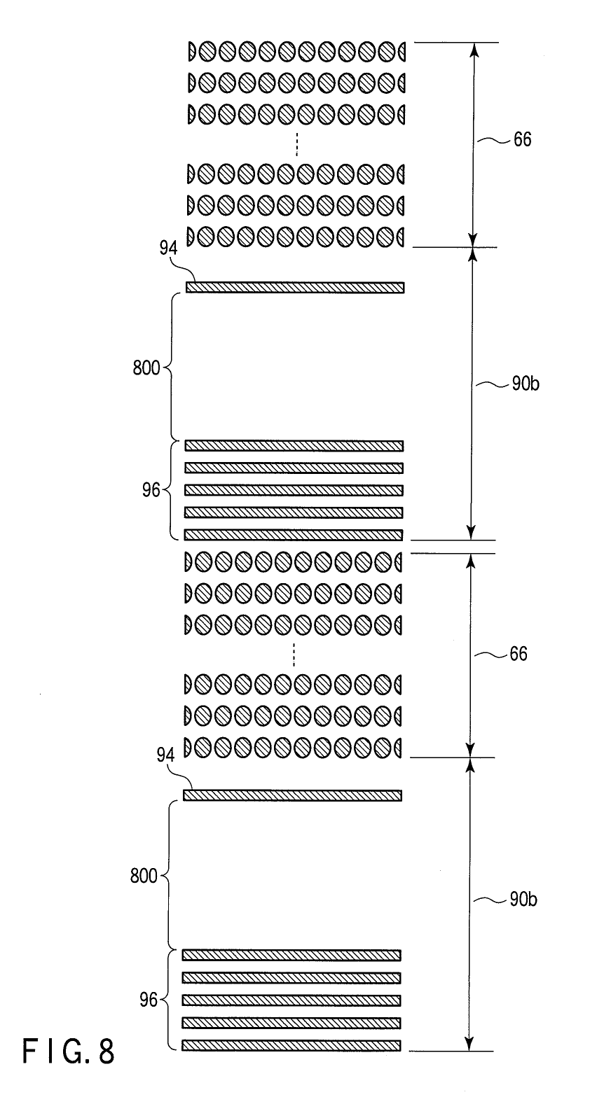

In each of the segments included in the data area 70, a resync area 90b and a recording dot area 66 are provided as shown in FIG. 6. The resync area 90b is an area in which a reference signal pattern 94 and a pseudo signal pattern 96 have been recorded as shown in FIG. 8. The pseudo signal pattern 96 is a signal pattern for distinguishing between the resync area 90b and the aforementioned resync area 90a. The reference signal pattern 94 and pseudo signal pattern 96 included in the resync area 90b are formed by a nano-imprint manufacturing method.

The recording dot area 66, which has a plurality of bit patterns, is formed by a nano-imprint manufacturing method as shown in FIG. 8. The recording dot area 66 is a data recording area for recording user data. In the magnetic disk 10 of the patterned-media type, one magnetic body (a dot in the magnetic film) corresponds to a 1-bit bit pattern. A value of 0 or 1 is determined, depending on the direction in which the dot is magnetized. Suppose the recording capacity with which data can be recorded in each of the recording dot areas 66, that is, the number of bit patterns arranged circumferentially, is common to all of the recording dot areas 66. The recording capacity is determined on the basis of the capacity of the data management module in the disk drive 100. The data management module is a capacity module (e.g., 512 bytes) in which the recording and reproduction of user data is managed. Actually, the recording capacity of each of the recording dot areas 66 is a capacity obtained by adding the capacity of a data management module (e.g., 512 bytes) and additional data, such as an error correction code (ECC), or a capacity equal to an integral multiple of the resulting capacity.

[Configuration of PLL Circuit for a Clock Generation]

Next, the clock generation phase-locked loop (PLL) circuit (PLL circuit) 110 included in the hard disk controller (HDC) provided on the circuit board 20 will be explained with reference to FIG. 9.

As shown in FIG. 9, the PLL circuit 110 of the embodiment comprises a resync extraction module 114, a servo pre-resync extraction module 116, a write clock PLL 112A, and a servo clock PLL 112B.

The write clock PLL 112A includes a phase comparison module 112, a loop filter 124, a voltage-controlled oscillator (VCO) 126, and a frequency division module 128. The servo clock PLL 112B includes a phase comparison module 132, a loop filter 134, a VCO 136, and a frequency division module 138.

Each of the phase comparison modules 122, 132 converts the phase difference between two input signals into a voltage and outputs the voltage. The loop filters 124, 134 are for performing phase compensation. Each of the VCOs 126, 136 controls the frequency of an output pulse according to an input voltage. The write clock PLL 112A locks the PLL with reference to the signals of reference signal patterns 92, 94 of the resync areas 90a, 90b extracted at the resync extraction module 114. Moreover, the servo clock PLL 112B also locks the PLL with reference to the signal of reference signal pattern 92 of the resync area 90a extracted at the servo pre-resync extraction module 114.

Here, since each of the reference signal patterns 92, 94 is extracted at regular intervals in either the servo clock or write clock, the PLL circuit 110 can constantly lock the PLL during the time when the disk is rotating (which is called an always-clocking method).

As described above, the PLL circuit 110 of the embodiment generates a write clock on the basis of the reference signal patterns 92, 94 extracted from the resync areas 90a, 90b. The write clock is used as a synchronization signal (timing) in recording write data in the recording dot area 66 (or bit pattern area). That is, in writing data (user data), the magnetic head 38 is positioned in a target bit pattern position on the recording dot area 66 as shown in FIG. 10A. Thereafter, as shown in FIG. 10B, the write element of the magnetic head 38 records data (one bit) in the target bit pattern position in synchronism with the write clock generated by the PLL circuit 110. The write clock has the same frequency and phase as those of the bit pattern arrangement as shown in FIGS. 10A and 10B.

While in the embodiment, the frequency of the write clock has coincided with the frequency of the bit pattern, the invention is not limited to this. For instance, the frequency of the write clock may be two or more times that of the bit pattern, provided that the relationship between the write clock and bit pattern is clear.

In the actual structure of the magnetic head 38, the read element and write element are provided on the head slider 16 in such a manner that they are physically separated from each other. Accordingly, it is seen from what is read by the read element that there is a strong possibility that the phase of the write clock generated by the PLL circuit 110 will differ from the phase of a write clock actually required by the write element. In the embodiment, as described above, it is assumed that the write element and read element have been arranged in the same position for convenience sake. A structure where the read element and write element are physically separated from each other has been disclosed in, for example, Jpn. Pat. Appln. KOKAI Publication No 2006-164349.

As described above, the configuration of the embodiment is such that a plurality of segments SG each of which has resync areas 90a, 90b including reference signal patterns 92, 94 for synchronizing the timing of writing data are provided in each of a plurality of zones Z₁ to Z₅ divided radially on the magnetic disk 10. In this case, as shown in FIG. 4, the number of segments in each of zones Z₁ to Z₅ is set to an integer which has a common divisor M (in this case, M=100). Accordingly, since the number of segments in each zone is an integer, it is possible to cause each segment in the zone to have the same capacity. This prevents the servo area of the next sector from lying directly below the magnetic head 38 while writing data management modules (e.g., 512 bytes) of data (user data). That is, there is no need to perform a complicated process (or data management) of interrupting the process of recording data management modules of data and recording the remaining data in the next sector. In addition, it is possible to prevent a decrease in the efficiency of recording data as a result of writing additional data.

Furthermore, since the number of segments in each zone has the common divisor M, the number of places where the segments in the individual zones align in a radial direction on the magnetic disk 10 is at least M. Accordingly, setting servo areas 60 in the M places enables a servo area 60 to lie just under the magnetic head 38 at regular time intervals. This makes it unnecessary to provide a servo preamble area and a write preamble area on the magnetic disk 10, which improves the efficiency of recording and reproducing data.

In the embodiment, servo data in the servo area 60 is recorded in the segments adjoining boundary lines B0, B1, . . . at a constant angular velocity. Of the segments, the areas in which servo data in the servo area 60 is not recorded are management information recording areas 64 in which non-user management information is to be recorded. Consequently, the equally-divided segments can be used effectively without leaving any unused area.

Moreover, in the embodiment, since the structure of the resync areas 90a adjoining the servo areas is made different from the structure of the other resync areas 90b, the positions of the servo areas 60 can be grasped even if a servo preamble or the like is not provided.

While in the embodiment, the number of segments as shown in FIG. 4 has been used, the number has been presented by way of example only. That is, various segment numbers may be used, provided that the aforementioned equation (1) is satisfied. In addition, while in the embodiment, all the segments on the magnetic disk have the same capacity, they may differ in capacity. For instance, if all the segments have at least a capacity determined on the basis of the capacity of a data management unit, the same effect as that of the embodiment can be obtained. The capacity is a capacity obtained by adding additional data to the capacity of a data management unit.

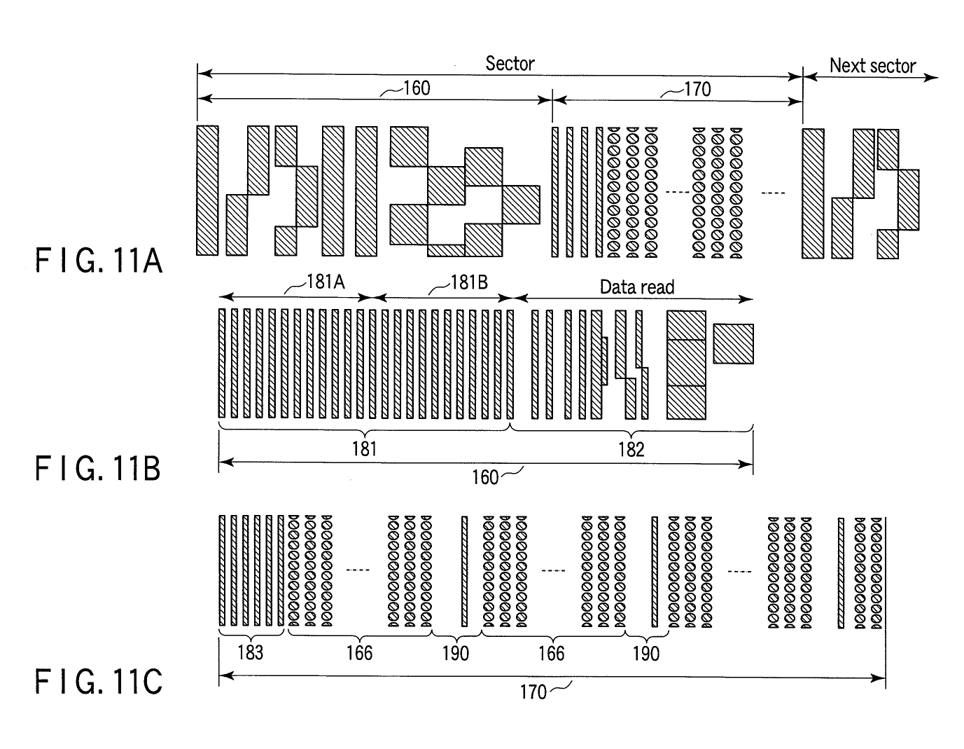

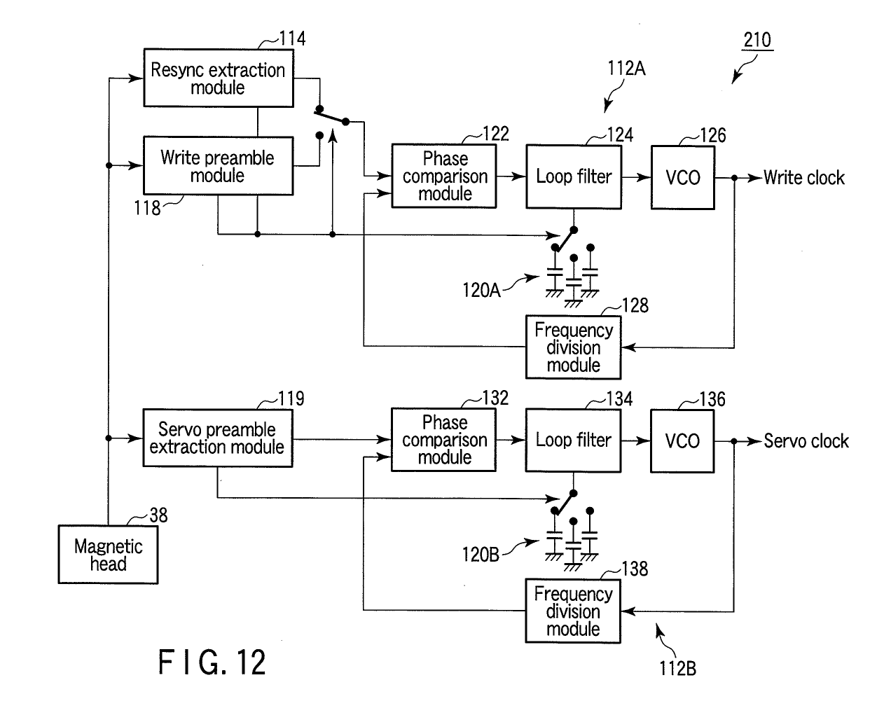

Next, a modification of the embodiment will be explained with reference to FIGS. 11A to 11C and 12.

FIG. 11A shows the structure of the magnetic disk 10 of the patterned media type. In FIG. 11A, a servo area 160 and a data area 170 are provided in one sector. The servo area 160 includes a servo preamble 181 and a servo mark 182 as shown in FIG. 11B. The servo preamble 181 includes an area 181A used for changing the magnetic head 38 from a write operation by the write element to a read operation by the read element and an area 181B used for subsequent PLL acquisition. The servo mark 182 is read in reading servo data.

Since the servo preamble 181 cannot be read until a read operation has been changed to a read operation, it is formed over a wide range. Specifically, for example, the servo preamble 181 occupies about 50% of the entire servo area 160.

As shown in FIG. 11C, the data area 170 includes a plurality of sets of a write preamble 183 provided in the leading area, a recording dot area 166, and a resync area 190. The write preamble 183, which actually has the same pattern as that of the servo preamble 181 of FIG. 11B, is used for PLL acquisition for a write clock using the pattern. The resync area 190 is used to lock the PLL again to maintain the write clock generated at the write preamble 183 with high accuracy until the end of the data area is reached.

FIG. 12 is a block diagram of a PLL circuit 210 for a clock generation. As shown in FIG. 12, the PLL circuit 210 generates a servo clock and a write clock independently. Specifically, a servo clock PLL 112B performs PLL acquisition with the servo preamble extracted at a servo preamble extraction module 119 in a state where the filter time constant is made smaller at a time constant switching module 120B. In a state where the filter time constant is made larger, the oscillating frequency of the VCO 136 is maintained.

In the write clock PLL 112A, a phase comparison module 122 performs phase comparison in both of the write preamble extracted at the write preamble extraction module 118 and the resync area extracted at the resync extraction module 114. The time constant switching circuit 120A switches between three time constants: a time constant for the preamble area, that for the resync area, and that for the other.

As described above, in the clock generation PLL circuit 210, the time constant switching circuits 120A, 120B switch between filter time constants. In contrast, the PLL circuit 110 of the embodiment need not switch between constants of filter time, which makes the circuit configuration relatively simple.

Furthermore, with the magnetic disk shown in FIGS. 11A to 11C, it is necessary to secure a wide area for arranging servo preambles and write preambles. In contrast, since the magnetic disk 10 of the embodiment uses the always-clocking method, there is no need to provide a servo preamble area and a write preamble area, which increases the efficiency of recording and reproducing data.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk comprising:
a plurality of zones divided in radial directions on a magnetic recording surface; and
a plurality of segments in each of said plurality of zones, each segment comprising a data recording area comprising a data recording unit of magnetic material and a first resync area comprising a reference signal pattern configured to set the timing of writing data in the data recording, the number of said plurality of segments in each of the zones being an integer having a common divisor.

2. The magnetic disk of claim 1, wherein the plurality of segments in each of the zones comprises servo areas with servo data recorded,
the segments are arranged as boundary parts of a plurality of sectors of each of the zones, and
the number of the sectors is not less than the common divisor.

3. The magnetic disk of claim 2, wherein the segments comprising the servo areas comprises a management information recording area for recording disk drive management information.

4. The magnetic disk of claim 2, wherein the segments comprising the servo areas comprise a second resync area in which a reference signal pattern for generating a servo clock is recorded.

5. The magnetic disk of claim 4, wherein each of the segments comprises an area in which a signal pattern for distinguishing between the first resync area and the second resync area is recorded.

6. The magnetic disk of claim 1, wherein the common divisor corresponds to the number of sectors of each zone, and the number of segments in each of the zones is equal to a value obtained by multiplying the number of sectors by an integer differing according to the position of the radius of each of the zones.

7. A disk drive comprising:
a magnetic disk of a patterned media type;
a magnetic head which records and reproduces data on and from the magnetic disk; and
a controller which controls the recording and reproduction of data on and from the magnetic disk via the magnetic head, the magnetic disk comprising:
a plurality of zones divided radially on a magnetic recording surface; and
a plurality of segments included in each of said plurality of zones, each segment comprising a data recording area comprising data recording modules of magnetic material and a first resync area comprising a reference signal pattern for setting the timing of writing data in the data recording area, the number of said plurality of segments included in each of the zones being an integer having a common divisor.

8. The disk drive of claim 7, wherein
the recording capacity of each of the segments is set according to a data management capacity managed by the controller.

9. The disk drive of claim 7, wherein the controller comprises a PLL circuit, which is configured to generate a write clock to record data in the data recording area by using the reference signal pattern extracted from the first resync area.

10. The disk drive of claim 7, wherein the magnetic disk comprises segments comprising servo areas in which servo data has been recorded in said plurality of segments in each of the zones and the segments comprising servo areas with a second resync area comprising a reference signal pattern for generating a servo clock, and
the controller comprises a PLL circuit which generates a servo clock for reproducing a servo from the servo area by using the reference signal pattern extracted from the second resync area.
